(19) United States
(12) Patent Application Publication
(10) Pub. No.: US 2007/0070635 A1
(43) Pub. Date: Mar. 29, 2007

(54) Free mounting type light emitting device

(76) Inventor: Chih Chung Tao, Taipei (TW)

Correspondence Address: PRO-TECHTOR INTERNATIONAL SERVICES, 20775 NORADA CT., SARATOGA, CA, 95070, US

(21) Appl. No.: 11/241,115

(22) Filed: Sep. 29, 2005

(51) Int. Cl. F21V 15/00

(52) U.S. Cl. 362/362

(57) ABSTRACT

A free mounting type light emitting device is disclosed to include a control unit, which is formed of a control circuit board, a battery and a switch, a light emitting unit, which includes LED chips and a flexible transmission line that connect the LED chips to the control unit for allowing the control circuit board to the operation of the light emitting elements, and a package, which encapsulates the control unit and the light emitting unit and has a double-sided adhesive tape (or hook and loop materials) at the back side for mounting.

### BACKGROUND OF THE INVENTION

1. Field of the Invention

The present invention relates to light emitting devices and more particularly, to a free mounting type light emitting device, which is convenient for carrying by the user or mounting on any product for decoration and illumination purposes as well as for producing a warning visual signal.

2. Description of the Related Art

A commercial thin type signal device is known as shown in FIG. 1. This design of thin type signal device comprises a package 6 and a light-emitting device 7. The package 6 comprises a transparent display zone 61 and a blocked zone 62 at one end of the transparent display zone 61. The light-emitting device 7 comprises a power source (battery) 71, a control circuit board 72, and a light guide 73. The light guide 73 is embedded in the transparent display zone 61. The power source 71 and the control circuit board 72 are embedded in the blocked zone 62. When switched on the switch at the control circuit board 72, electricity is transmitted to the control circuit board 72, thereby causing the control circuit board 72 to drive the LEDs (light emitting diodes) thereon to emit light toward the light guide 73.

Because light rays from the LEDs are guided out of the transparent display zone 61 through the light guide 73, the intensity of light is low. Therefore, this design of light emitting device is not suitable for illumination. Further, when this design of light emitting device is carried on the vest of a person working on the street, the produced visual signal is weak, not indicative to persons approaching different sides.

### SUMMARY OF THE INVENTION

The present invention has been accomplished under the circumstances in view. It is the main object of the present invention to provide a free mounting type light emitting device, which has a thin and compact size convenient for installation in any device for decoration and illumination purposes as well as for producing a warning visual signal.

To achieve this and other objects of the present invention, the free mounting type light emitting device comprises a control unit, which is formed of a control circuit board, a battery and an on/off switch, a light emitting unit, which includes LED chips and a flexible transmission line that connect the LED chips to the control unit for allowing the control circuit board to the operation of the light emitting elements, and a package, which encapsulates the control unit and the light emitting unit and has a double-sided adhesive tape (or hook and loop materials) at the back side for mounting. The package comprises a transparent display zone that holds the light-emitting unit on the inside, and a blocked zone that is connected to one end of the transparent display zone and holds the control unit on the inside. The blocked zone comprises thin-film operating portions corresponding to the on/off switch.

### BRIEF DESCRIPTION OF THE DRAWINGS

FIG. 1 is a thin type signal device according to the prior art.

FIG. 2 is a perspective view of a free mounting type light-emitting device according to the present invention (the package excluded).

FIG. 3 is an enlarged view of a part of FIG. 2.

FIG. 4 is a schematic sectional view of a part of the free mounting type light-emitting device according to the present invention.

FIG. 4A is similar to FIG. 4 but showing the fastening device removed from the package.

FIG. 5 is a schematic top plain view of the free mounting type light-emitting device according to the present invention.

FIG. 6 shows an application example of the present invention.

FIG. 7 shows another application example of the present invention.

FIG. 8 is substantially similar to FIG. 5, but showing another pattern of the light-emitting unit.

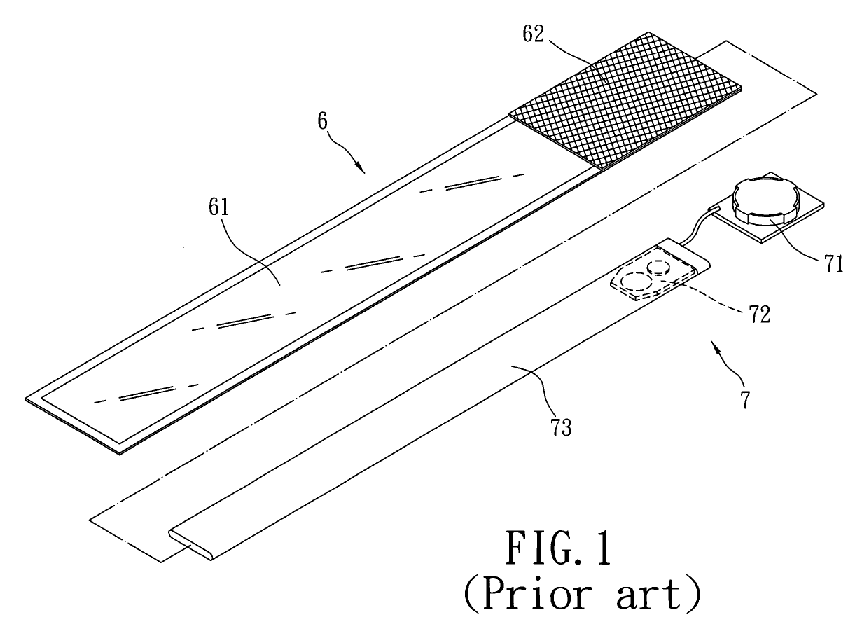

### DETAILED DESCRIPTION OF THE PREFERRED EMBODIMENT

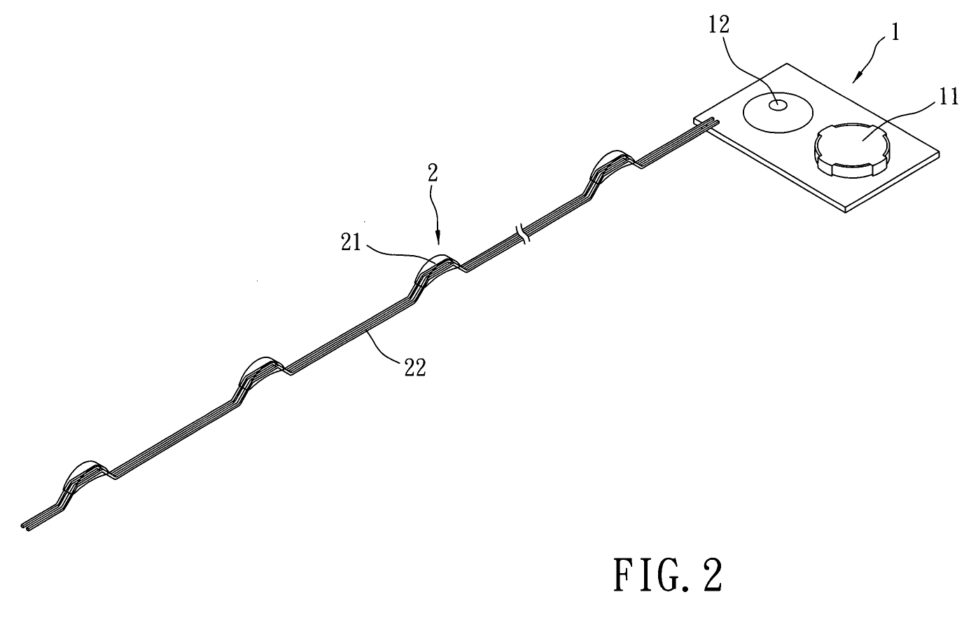

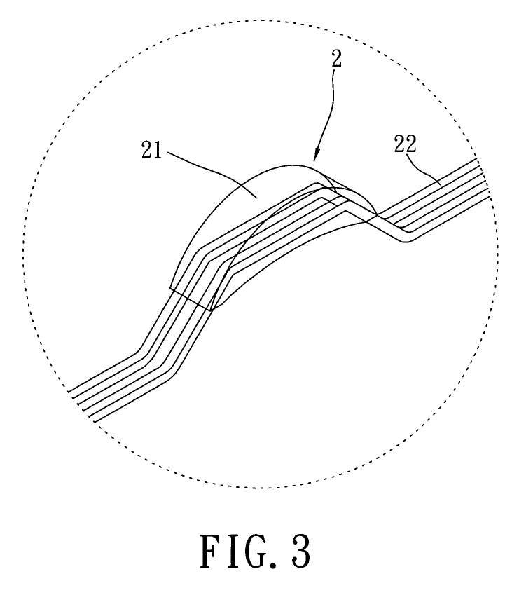

Referring to FIGS. 2 and 3, a free mounting type light emitting device in accordance with the present invention can freely be fastened to the user's personal items or any of a variety of devices for decoration or illumination, or for providing a visual signal. The free mounting type light-emitting device comprises a control unit 1 and a light-emitting unit 2. The control unit 1 comprises a control circuit board (not shown), a power source, for example, a battery 11, and a switch 12. The battery 11 provides the necessary working voltage to the light-emitting unit 2 when the switch 12 is switched on.

The light-emitting unit 2 comprises a plurality of light emitting elements 21, and a transmission line 22 that connects the light emitting elements 21. Preferably, the light emitting elements 21 are high power, high brightness LED (light emitting diode chips) for the advantages of low power consumption and limited space occupation. The transmission line 22 is a flexible flat cable that can be bent into any of a variety of patterns, set in an accommodating chamber inside any of a variety of produces, or wound round any of a variety of products. In addition to the advantages of light, thin, short and small characteristics, each LED chip (light emitting element) 21 has multiple light emitting sides that emit light in different directions.

When switched on the switch 12 of the control unit 1, the control circuit board of the control unit 1 turns on the LED chips 21 or drives the LED chips 21 to flash subject to a predetermined flashing mode.

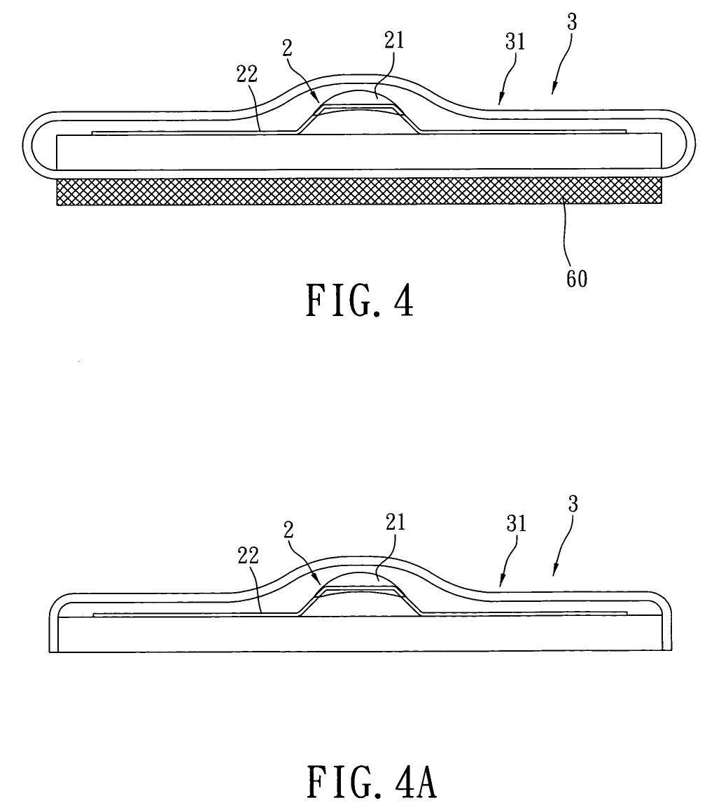

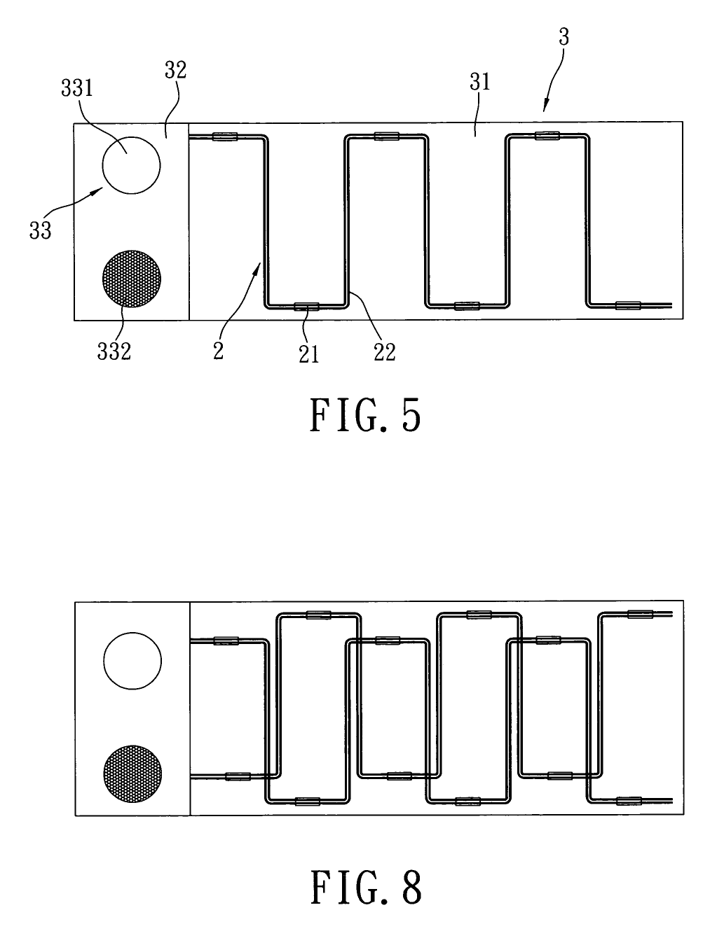

Referring to FIGS. 4 and 5, the aforesaid light emitting device is packaged in a package 3, which comprises a flat transparent display zone 31, which has the light emitting unit 2 embedded therein, and a blocked zone 32, which is connected to one end of the transparent display zone 21 and has the aforesaid control unit 1 embedded therein. By means of the flexible characteristic of the transmission line 22, the light-emitting unit 2 is bent into a predetermined shape before embedding in the transparent zone 31 of the package 3. The blocked zone 32 has thin-film switching means 33, which includes a first switching membrane 331 for switching on the light emitting device, and a second switching membrane 332 for switching off the light-emitting device.

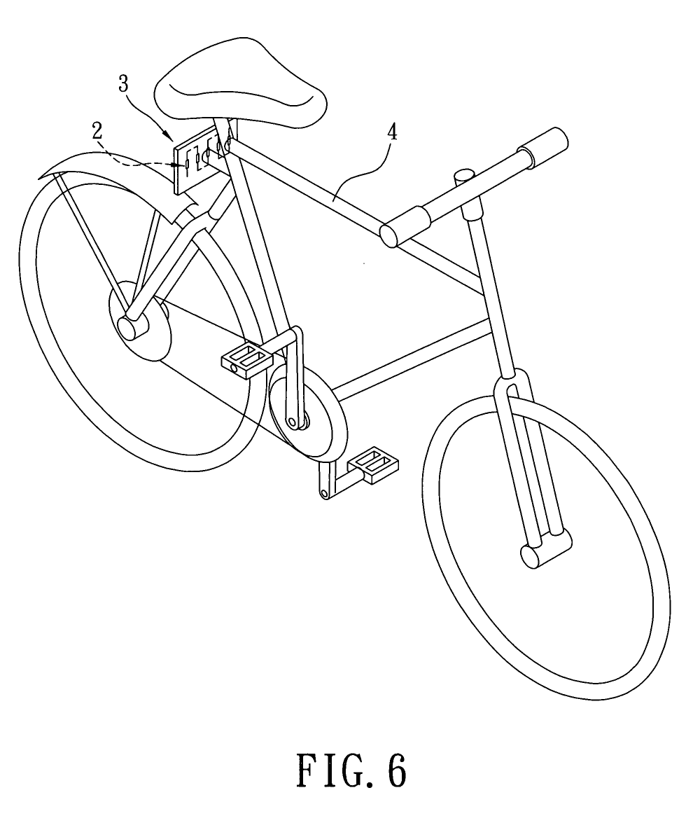

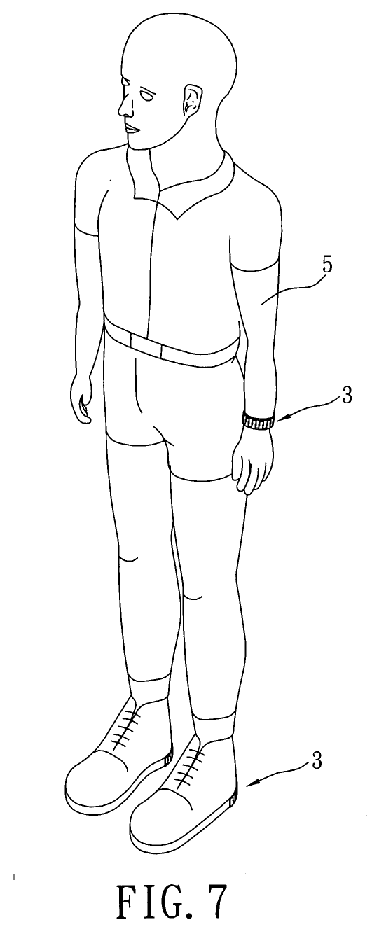

Referring to FIGS. 6 and 7 and FIG. 4 again, a fastening device 6 (such as double-sided adhesive tape or hook and loop materials) is provided at the back side of the package 3 for fastening to a transportation vehicle (for example, a bicycle) 4 (see FIG. 6), the body or an article on the body of the user 5 (see FIG. 7), a building, or any of a variety of other articles for illumination or decoration purpose, or for giving a visual signal.

The embodiment shown in FIG. 8 is substantially similar to the embodiment shown in FIG. 5 with the exception of the pattern of the light-emitting unit 2. Further, the LED chips 21 according to this embodiment produce different colors. Under the control of the control circuit board, the light-emitting unit 2 produces a color visual effect.

In addition to the aforesaid embodiments, the light-emitting device of the present invention can be made in the form of a thin card convenient for carrying in the pocket. When in the dark, the user can pick up the thin card type light-emitting device from the pocket for use as a mini hand flashlight.

Further, because the transmission line 22 is flexible, the light-emitting unit 2 can be directly wound round a Christmas tree, doorframe, beam, or any of a variety of other devices.

Further, a buzzer may be added to the control unit 1 so that the free mounting type light emitting device can product sound and lighting effects.

Although particular embodiments of the invention have been described in detail for purposes of illustration, various modifications and enhancements may be made without departing from the spirit and scope of the invention.

What the invention claimed is:

1. A free mounting type light emitting device comprising:
a light emitting assembly, said light emitting assembly comprising a control unit, said control unit comprising a control circuit board, a power source and on/off switch means, and a light emitting unit, said light emitting unit comprising a plurality of light emitting elements and a transmission line that connects said light emitting elements to said control unit for allowing said control circuit board to control transmission of electricity from said power source to said light emitting elements and the operation of said light emitting elements; and
a package encapsulating said light emitting assembly.

2. The free mounting type light emitting device as claimed in claim 1, wherein said light emitting elements are light emitting diodes.

3. The free mounting type light emitting device as claimed in claim 1, wherein said light emitting elements are color light emitting device that produce different colors of light.

4. The free mounting type light emitting device as claimed in claim 1, wherein said light emitting elements are LED (light emitting diode) chips each having multiple light emitting sides.

5. The free mounting type light emitting device as claimed in claim 1, wherein said transmission line is a flexible flat cable bendable into a predetermined pattern.

6. The free mounting type light emitting device as claimed in claim 1, wherein said package comprises a transparent display zone that holds said light emitting unit on the inside, and a blocked zone that is connected to one end of said transparent display zone and holds said control unit on the inside, said blocked zone comprising thin-film operating portions corresponding to said on/off switch means.

7. The free mounting type light emitting device as claimed in claim 1, further comprising a double-sided adhesive tape provided at a back side of said package for mounting.

8. The free mounting type light emitting device as claimed in claim 1, further comprising hook and loop materials provided at a back side of said package for mounting.
